(19) United States
(12) Patent Application Publication
(10) Pub. No.: US 2007/0208994 A1
(43) Pub. Date: Sep. 6, 2007

(54) Systems and methods for document annotation

(76) Inventors: Frederick A. Reddel V, Greensboro, NC (US); W. Douglas Young, Summerfield, NC (US); Aaron Kyle Pickrell, Greensboro, NC (US)

Correspondence Address: KILPATRICK STOCKTON LLP, 1001 WEST FOURTH STREET, WINSTON-SALEM, NC, 27101, US

(21) Appl. No.: 11/713,904

(22) Filed: Mar. 5, 2007

Related U.S. Application Data
(60) Provisional application No. 60/778,666, filed on Mar. 3, 2006.

(51) Int. Cl. G06F 17/00

(52) U.S. Cl. 715/512; 715/511; 715/513

(57) ABSTRACT

Methods and systems for annotation documents are disclosed. For example, a method for annotating a document includes creating a collaboration, adding a document to the collaboration, adding a user to the collaboration, selecting the document, creating an annotation, associating the annotation with the document, and storing the annotation on a processor-based device.

### CROSS-REFERENCES TO RELATED APPLICATION

This application claims priority to U.S. Provisional Patent Application No. 60/778,666 filed Mar. 3, 2006, entitled “System and Method for Electronic Voice Annotation,” the entirety of which is hereby incorporated by reference.

### FIELD OF THE INVENTION

The present invention relates to systems and methods for annotating documents. The present invention more particularly relates to distributed collaboration on electronic documents and files.

### BACKGROUND

The need for efficiently annotating and commenting on electronic media, such as documents, video files, audio files, and other media, that is being shared and reviewed by one or more people is increasingly in demand as the use of mobile devices and the Internet becomes more prevalent. Typical methods for collaborating on electronic documents and files include the use of a software application, and possibly a telephone conference call, that requires all participants to collaborate at the same time. In some cases, annotations and comments may be recorded for future review, but they can be limited and cumbersome to manage or use outside of the software application itself. These existing collaboration methods tend to be inefficient because they may require users to collaborate in an unnatural or undesirable manner.

An example of a convention method for collaborating on digital media involves the author distributing an electronic file via email to one or more collaborators. The email may ask for comments and suggested changes from each of the collaborators to be returned to the sender. This method may have many disadvantages. For example, the method may require the author to keep one or more separate copies of the electronic file, wherein each copy of the electronic file may comprise comments, changes, or suggestions of one or more of the collaborators. The author may then need to review each of the separate copies to determine what changes may be needed in the original file.

Another method may involve an online collaboration session in which one or more collaborators can comment on the electronic document, either by voice or by entering text. This method may be disadvantageous because it limits collaboration to only those collaborators that are online at the time of the collaboration. Further, this method is disadvantageous because it may be difficult to review and incorporate comments, suggestions, or annotations from the collaboration session.

### SUMMARY

Embodiments of the present invention provide systems, methods, and computer readable media for annotating documents. For example, in one illustrative embodiment, a method for annotating documents comprises creating a collaboration, adding a document to the collaboration, and adding a first user and a second user to the collaboration. The illustrative embodiment further comprises selecting the document, creating an annotation, associating the annotation with the document, and storing the annotation on a processor-based device.

In one illustrative embodiment, a single user may create a collaboration, add a document to the collaboration, the document authored by the single user, add the single user to the annotation, create an annotation, associate the annotation with the document, and store the annotation in the collaboration. The single user may then retrieve the annotation from the collaboration, retrieve the document from the annotation, and output the annotation.

These illustrative embodiments are provided as examples to aid in understanding of the present invention. As will be apparent to those of skill in the art, many different embodiments of the present invention are possible. Additional uses, advantages, and features of the invention are set forth in the illustrative embodiments discussed in the detailed description herein and will become more apparent to those skilled in the art upon examination of the following.

### BRIEF DESCRIPTION OF THE DRAWINGS

These and other features, aspects, and advantages of the present invention are better understood when the following Detailed Description is read with reference to the accompanying drawings, wherein:

FIG. 1 shows a system for annotating a document according to one embodiment of the present invention;

FIG. 2 shows a collaboration 201 according to one embodiment of the present invention; and

FIG. 3 shows a method 300 for annotating a document according to one embodiment of the present invention.

### DETAILED DESCRIPTION

Various embodiments of the present invention provide systems, methods, and computer-readable media for annotating documents.

One illustrative embodiment of a system of the present invention comprises a central data storage system and one or more computers connected to the central data storage system through a network. On the data storage system, a collaboration is created. A collaboration is a virtual container that can have within it documents, users, annotations, working groups, and other data that might be helpful in a collaborative effort. For example, in the illustrative system, a collaboration may contain one or more documents associated with a business proposal. The collaboration may also include one or more user accounts that are authorized to access the documents within the collaboration, such as the members of a sales and marketing team. The group of users may each access and edit any of the documents stored within the collaboration. In addition, each of the users may generate annotations that may be associated with one or more documents. For example, a first user may review a budget document using his personal computer and record a voice annotation regarding the first user's thoughts and criticisms of the budget document. The first user may then associate the annotation with the document and save the annotation on the data storage system. Once the annotation has been saved to the data storage system, other users within the collaboration may access and listen to the first user's annotation.

Alternatively, instead of associating the annotation with the document as a whole, the first user may associate the annotation to a particular part of the document. For example, the first user may associate the annotation with a section of the document, or multiple sections of the document. The first user may alternatively associate the annotation with a specific point on the document, or a region on the document. For example, the first user may associate the annotation with a data point on a graph, or with a region within a diagram.

A second user within the collaboration may then select the document and receive the annotations associated with the document. The second user may then elect to listen to the annotation associated with the document. For example, if the second user accesses the document using a personal digital assistant (PDA) or cell phone, the second user may be able to select the document and listen to the annotation using her PDA or cell phone. If the first user has associated the annotation with a particular section or sections, point, or region of the document, the second user may listen to the annotation by selecting the region of the document having the associated annotation. The second user may then create a second annotation, such as, for example, a textual annotation. The second user may associate the second annotation with the document, and store the second annotation on the data storage system.

Using the illustrative embodiment of the present invention described above, one or more users may advantageously be able to collaborate more efficiently by creating annotations to documents and associating the annotations with the documents or portions of the documents. This may allow multiple users to work independently on the documents, either simultaneously or at different times, and communicate effectively without the need for scheduling conferences or meetings, or creating and distributing multiple revisions of the documents to each member of the collaboration. Instead, the users may provide annotations to a document for review by other members of the team, who may then act independently based on those annotations.

One illustrative embodiment of the present invention may allow a single user to create and annotate his own documents. For example, a user may create a collaboration, create a document, and add the document to the collaboration. The user may perform the preceding steps while working at a personal computer, such as at home or in an office. The user may then create an annotation. For example, if the user is traveling and identifies important subject matter to be added to the document, the user may create an annotation using a processor-based device, such as an electronic voice recorder or a PDA (such as a Blackberry™), associate the annotation with the document, and store the annotation in the collaboration. For example, a user may make a telephone call to a remote device, which may answer the call and record the contents of the telephone call, including the comments or annotations, and/or, an association with a document (such as, for example, by recognizing a document number entered by key presses made by the user), and store the annotation in the collaboration. In another example, the user may receive comments from a third party, such as from a customer or client, related to the subject matter of the document. The user may contemporaneously, or at a later time, create an annotation based on the comments from the third party, associate the annotation with the document, and store the annotation in the collaboration. Using such an embodiment, a user may effectively create and store annotations associated with a document while traveling or when it may not be convenient to revise the document.

This example is given to introduce the reader to the general subject matter discussed herein. The invention is not limited to this example. The following sections describe various embodiments of systems and methods for annotating documents.

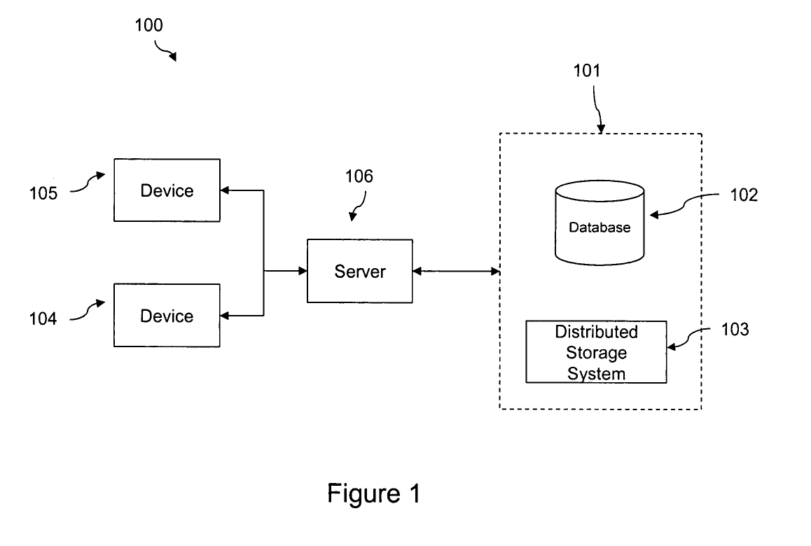

Referring now to the drawings in which like numerals refer to like elements throughout the several Figures, FIG. 1 shows a system 100 for annotating a document according to one embodiment of the present invention. In the embodiment shown, server 106 is in communication with data storage system 101. A plurality of devices 104, 105 are in communication with server 106.

In the embodiment shown, data storage system 101, devices 104, 105, and server 106 each comprise a processor-based device. A processor in a processor-based device comprises a computer-readable medium, such as a random access memory (RAM) coupled to the processor. The processor executes computer-executable program instructions stored in memory, such as executing one or more computer programs for generating vibrotactile haptic effects. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage or transmission device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other forms of computer-readable media may transmit or carry instructions to a computer, such as a router, private or public network, or other transmission device or channel. The processor, and the processing, described may be in one or more structures, and may be dispersed through one or more structures. The processor may comprise code for carrying out one or more of the methods (or parts of methods) described herein.

In the embodiment shown, data storage system 101 comprises a database 102 and a distributed storage system 103. In some embodiments, data storage system 101 may comprise a plurality of servers in one or more locations. For example, data storage system may comprise one or more servers located in a first location and one or more servers located in a second location. In such an embodiment, a large corporation with worldwide sales offices may have a server local to each office, each of which may be in communication a central server or the servers in each office. In one embodiment, data storage system 101 may comprise the processor-based device on which a user is working. For example, an individual may configure an embodiment of the present system entirely within a single processor-based device. In such an embodiment, the database 102 may be incorporated into the user's processor-based device, such as the user's personal computer, PDA, cell phone or other device.

Database 102, in the embodiment shown, comprises a computer or server executing a database, such as a commercially available database or a proprietary database system. In addition, database 102 is in communication with server 106 over a local area network. In one embodiment database 102 is in communication with server 106 over a wide area network, or other type communication link configured to transmit a signal may be used including, but not limited to, a circuit; a network; a wireless communications link including but not limited to 802.11 wireless Ethernet, radio frequency transmission/reception or Bluetooth; a system bus; USB; or FireWire. In one embodiment, database 102 comprises a distributed database stored on a plurality of computers or servers. In one embodiment, database 102 comprises a file system on a non-volatile storage device, such as a hard drive or a flash drive.

In the embodiment shown in FIG. 1, data storage system comprises distributed storage system 103, which may comprise one or more processor-based devices. For example, in one embodiment, distributed storage system 103 may comprise two processor-based devices. In such a configuration, a first portion of data to be stored by a first processor-based device, and second portion of the data may be stored by a second processor based device. In one embodiment, database 102 may be stored on a processor-based device in communication with the distributed storage system 103, but not incorporated into the distributed storage system 103. For example, database 102 may be incorporated into a first computer, and distributed storage system 103 may comprise a second computer and a third computer, where the database 102 and the distributed storage system 103 are in communication. Multiple embodiments of a distributed storage system are described in more detail in U.S. patent application Ser. No. 11/526,532, filed Sept. 25, 2006, entitled “Systems and Methods for Remote Storage of Electronic Data,” the entirety of which is hereby incorporated by reference.

In the embodiment shown, data storage system 101 is configured to store at least one document, store at least one annotation, store an association between a document and an annotation, transmit and receive a document, and transmit and receive an annotation. In one embodiment, data storage system 101 may store a document by storing the document within database 102. In one embodiment data storage system 101 may store a document by storing the document in the distributed storage system 103. In a further embodiment, data storage system 101 may comprise a single processor-based device and store a document as a file on a non-volatile storage device local to the processor-based device, such as, without limitation, an internal or external hard drive, an internal or external flash drive, and/or an internal or external optical disk.

Data storage system 101, in one embodiment, may store a document in distributed storage system 103, and a location of the document within the distributed storage system in the database 102. In such an embodiment, data storage system 101 may store an annotation and an association between the annotation and the document in the database. For example, if annotation comprises a textual annotation, data storage system 101 may store the annotation in the database 102. In one embodiment, data storage system 101 may store an annotation in the distributed storage system 103 and a location of the annotation within the distributed storage system in the database 102. For example, a video annotation may be stored in the distributed storage system 103, and a location of the annotation within the distributed storage system in the database 102. Such an embodiment may be advantageous for storing large annotations efficiently in a storage system having a large capacity for data, while saving the location of the annotation in a database having less capacity for storage.

Devices 104 and 105, in the embodiment shown, may comprise any processor-based device, and need not each be the same type of device. For example, device 104 may comprise a cell phone and device 105 may comprise a personal computer. Other processor-based devices suitable for use in various embodiments of the present invention may comprise personal computers, laptops, servers, PDAs (such as a Blackberry™), or cell phones. Other processor-based devices suitable for use in one or more embodiments of the present invention would be apparent to one of ordinary skill in the art.

In the embodiment shown in FIG. 1, devices 104, 105 are in communication with server 106 and are configured to transmit data to and receive data from server 106, such as documents and annotations. For example, devices 104, 105 may be in communication with server 106 over a local area network (LAN) comprising Ethernet. In one embodiment, devices 104, 105 may be in communication with server 106 using different means of communication. For example, in one embodiment, device 104 may be in communication with server 106 over a LAN comprising Ethernet, and device 105 may be in communication with server 106 over a wireless cellular packet-switched and/or circuit-switched connection. Other suitable means of communication between a device 104, 105 and server 106 may comprise Ethernet (including over a LAN or a wide area network), telephone communications, cellular communications, wireless connections (such as 802.11a/b/g and Bluetooth), universal serial bus (USB), and FireWire. Other means of communication suitable for use in one or more embodiments of the present invention would be apparent to one of ordinary skill in the art.

In the embodiment shown in FIG. 1, server 106 may be any processor-based device. For example, in one embodiment server 106 may comprise a personal computer. In one embodiment, server 106 may be a LiveCargo Web Server. In such an embodiment, the server 106 may be in communication with a data storage system, for example a LiveCargo data center, in which information relating to the one or more selected documents can be stored. For example, the data center can store one or more documents or files as well as data related to the documents and/or files including, but not limited to, comments, voice annotations, or changes.

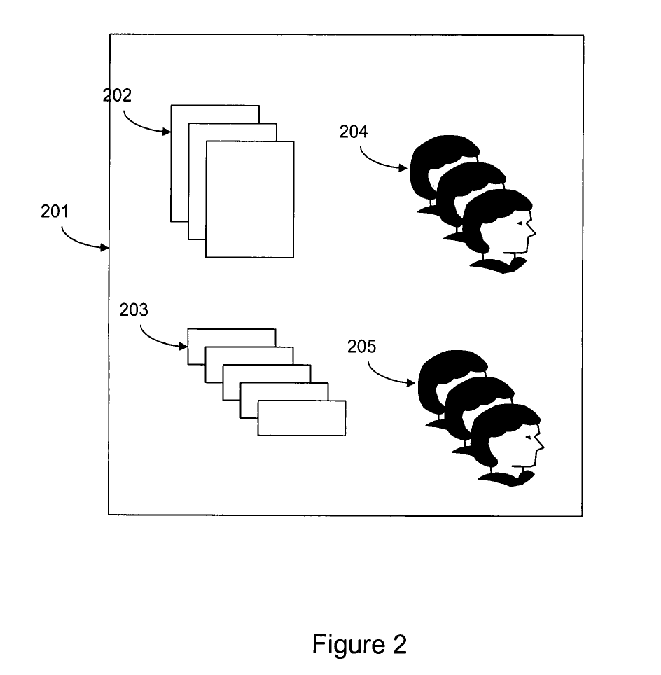

FIG. 2 shows a collaboration 201 according to one embodiment of the present invention. A collaboration 201, in one embodiment of the present invention, describes an electronic container in which may be included one or more documents 202, one or more users 204, one or more user groups 205, one or more annotations 203, or other elements that may be advantageously incorporated into a collaboration. For example, a collaboration 201 may include several members of a sales force, one or more documents 202 relating to products offered for sale and potential clients or customers, and annotations 203 of the documents 202 by the users 204, such as comments relating to the likelihood of a sale of a product to a customer, whether a customer should be a high priority or low priority customer, or status of the current relationship with the client. While the term ‘collaboration’ may be conventionally understood to be a joint effort of two or more participants, a collaboration in some embodiments of the present invention may include only a single user.

In addition, in one embodiment of the present invention, a collaboration 201 may comprise one or more levels of access to the collaboration. For example in one embodiment, a collaboration 201 may allow the following levels of access to the collaboration 201: administrator, contributor, and viewer. In such an embodiment, a user 204 of a collaboration 201 having an administrator level of access may be able to add or remove documents 202 from the collaboration 201, add or remove users 204 from the collaboration 201, change access levels for one or more users 204 within the collaboration 201, or delete annotations 203 from a collaboration 201. In other embodiments, the administrator access level may have additional abilities, such as locking or unlocking a collaboration 201, partitioning a collaboration 201 into sub-collaborations, or terminating a collaboration 201. A contributor to a collaboration 201 may be able to add documents 202 to a collaboration 201, edit documents 202 within a collaboration 201, add annotations 203 to a collaboration 201, or delete annotations 203 made by the contributor. A viewer to a collaboration 201 may be able to view documents 202 within the collaboration 201 and view annotations 203 within the collaboration 201, but not add or edit documents 202 or annotations 203. Other levels of access, as well as other access rights and privileges, or other permutations of those rights and privileges are included within the scope of the present invention.

One or more documents 202 may be included within a collaboration 201 in one embodiment of the present invention. A document 202 may be a word processing file, a portable document format (PDF) file, a spreadsheet, a presentation, a computer aided drafting (CAD) file, a medical imaging file (such as DICOM), an audio file (including mp3, raw, wave, and other audio formats), a video file (including mpeg, QuickTime™, Divx, AVI. Macromedia Flash, or other video file formats), or any other file having data capable of being stored electronically. Other types of documents 202 suitable for use with one or more embodiments of the present invention would be apparent to one of ordinary skill in the art. In one embodiment a document 202 may be associated with more than one collaboration 201. For example, a document 202 relating to current employees may be added to a collaboration 201 associated with a budget proposal, and with a collaboration 201 associated with human resources.

In one embodiment of the present invention, a user 204 or a group of users may be included in a collaboration 201. In a simple embodiment of the present invention, a collaboration 201 may include a single user 204. In such an embodiment, the user 204 may desire a simple way to draft and revise a document 202 or group of documents 202. A single user 204 may advantageously employ such an embodiment of the present invention to save thoughts or brainstorms for a later date. In one embodiment, multiple users 204 may be included in a collaboration 201. In such an embodiment, the multiple users 204 may each have access to one or more documents 202 and may each be able to create and store one or more annotations 203 associated with documents 202 within the collaboration 201. In one embodiment, the multiple users 204 may be divided into user groups 205. For example, if a collaboration 201 is created for preparing a business proposal, a plurality of user groups 205 may be defined, such as user groups 205 for sales, marketing, finance, and executives. Within each user group one or more users may be added (or removed). Each user group may have different levels of access to documents 202 and/or annotations 203 within the collaboration 201. For example, the finance group may have the ability add, edit, and delete documents 202 and annotations 203 relating to pricing of proposals or financial analysis, while the marketing team may only have the ability to view documents 202 and annotations 203 for such documents 202. In such an embodiment, users 204 may be subdivided into groups or teams within the collaboration 201 to effectively partition responsibilities. A user 204 or user group may also be a member of multiple collaboration 201s. For example, a user 204 may be a member of a collaboration 201 relating to a budget proposal and a collaboration 201 associated with hiring new employees. These and other embodiments of the present invention may allow multiple users 204 in different geographic areas to effectively and efficiently participate in a collaborative effort.

In the embodiment shown in FIG. 2, zero or more annotations 203 may be included in a collaboration 201. Annotations 203 comprise information relating to one or more documents 202, or portions of documents 202, within the collaboration 201. In various embodiments of the present invention, annotations 203 may comprise different forms of information and different quantities of information. Annotations 203 may comprise text, symbols, figures, diagrams, lines, shapes, drawings or artwork, audio (including without limitation speech, music, songs, and notes), and/or video (including live video and animation). An annotation 203 may comprise a highlighting of a portion of a document 202. For example, an annotation 203 according to one embodiment of the present invention may comprise a selection of text that has been highlighted to have a different color, font, or font attribute (such as, for example and without limitation, bold face type, italics, underline, or strikethrough). Other types of annotations 203 are within the scope of the present invention and would be apparent to one of ordinary skill in the art. In the embodiment shown in FIG. 2, annotations 203 may be stored within a collaboration 201 and may be accessed by one or more users 204. Additionally, annotations 203 may be added or deleted from a collaboration 201. For example, a user 204 may create an annotation 203 and store the annotation 203 within the collaboration 201. The user 204 may also associate the annotation 203 with one or more documents 202 or portions of documents 202 within the collaboration 201. An annotation 203 also may not be associated with any documents 202. For example, a user 204 may provide an unassociated annotation to provide a comment relating to the collaboration 201, or as a message to another user within the collaboration 201. Annotations 203 may also be modified by one or more users 204. For example, in one embodiment, a user 204 may modify the content of the annotation, such as by modifying text within an annotation 203. A user 204 may also modify an annotation 203 by changing an association of the annotation 203. For example, a user 204 may change an annotation 203 from being associated with a first document to being associated with a second document. In one embodiment of the present invention, a user 204 may change an annotation 203 from being associated with only a first document to being associated with a first document and a second document, or multiple documents 202. In one embodiment, a user 204 may change an annotation 203 from being associated with a portion of a document 202 to a different portion of the document 202, a portion of a different document 202, or multiple portions of the document 202 and/or different documents 202.

Annotations 203 may be associated with a document 202 in many different ways. In one embodiment, an annotation 203 may be associated with a specific coordinate within a document 202. For example, in such an embodiment, a specific location within a document 202, including a single point within the document 202, may be associated with an annotation 203. In one embodiment, an annotation 203 may be associated with multiple points within the document 202 or a region defined by a plurality of points.

In one embodiment, a collaboration 201 may be defined and created on server 106 and may have collaboration 201 data associated with database 102 and distributed storage system 103. For example, a collaboration 201 may include data for accessing database 102, such as an address and/or identifier for the database, a login account, and a password. The collaboration 201 may further include methods for storing, or persisting, data within database 102, such as annotations 203, locations (or pointers) to data, such as files, within the distributed storage system 103. In such an embodiment, the collaboration 201 may include data defining the documents 202 and users 204 within the collaboration 201, but also methods and data associated with persisting data within the data storage system 101 and access controls associated with users 204 and documents 202. Thus, a collaboration 201, in some embodiments of the present invention, may provide a full-featured construct in which a collaborative effort may be electronically defined and implemented, and may have the flexibility to accommodate any effort, from extremely simple, single-person efforts, to extremely complex multi-user, multi-disciplinary, multi-document, distributed collaborations. All of which are envisioned as being within the scope of the present invention.

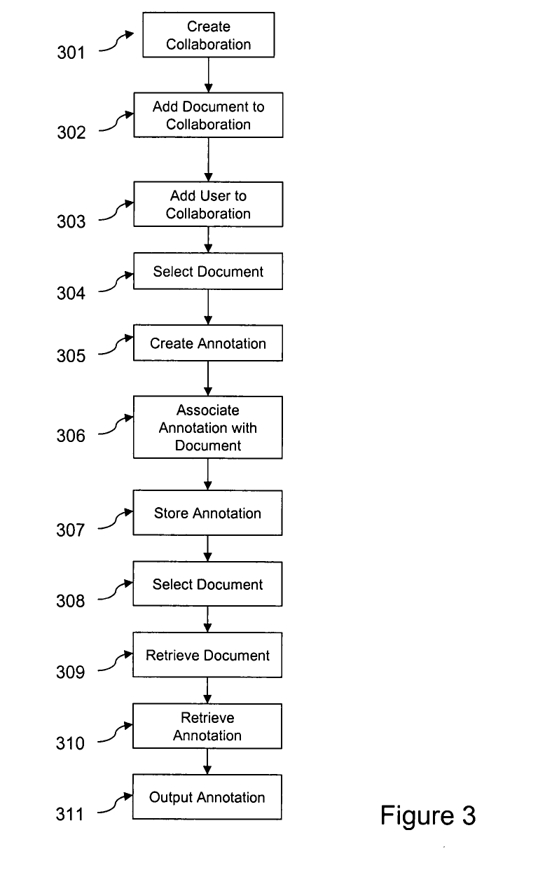

FIG. 3 shows a method 300 for annotating a document according to one embodiment of the present invention. The method begins with step 301, creating a collaboration. In one embodiment, a collaboration may be created by specifying one or more users to be included in the collaboration. In such an embodiment, the users may or may not be able add documents and annotations to the collaboration after it has been created, or one or more documents may be added by an administrator at a later time. In one embodiment, a collaboration may be created having one or more documents and one or more users. For example, a collaboration may be created having one or more documents, but with no users, as the group of people to be included had not yet been determined. It should be understood that creating a collaboration need not specify any one particular attribute of the collaboration, nor must a collaboration include any particular attribute. Creating the collaboration only need include specifying the attributes and characteristics minimally necessary to create the collaboration in the embodiment. In one embodiment, no characteristics or attributes need to be selected, and a completely empty collaboration may be created, wherein the attributes and characteristics of the collaboration may be specified with greater detail after creation.

In the embodiment shown in FIG. 3, Step 302 comprises adding a document to a collaboration. In such an embodiment, a document may be added by an administrator of the collaboration, a user of the collaboration, or the document may be added automatically. For example, in one embodiment, an administrator of the collaboration may select one or more documents to be included in the collaboration. Alternatively, or in addition, a user may add a document to a collaboration. In one embodiment, a document may be added to a collaboration. In such an embodiment, a collaboration may be created with a parameter specifying a type of document, or a location to search for documents to add to the collaboration. For example, a collaboration may be created having an attribute defining a directory in a file system having legal documents. The collaboration may then add the documents to the collaboration automatically. In a similar embodiment, the collaboration may have an attribute specifying documents relating to a particular subject. The collaboration may then search a file system or document repository for documents pertaining to the subject. The collaboration may also be configured to update the documents to be included in the collaboration, such as by monitoring a directory in a file system or a document repository for appropriate documents to add to the collaboration.

Step 303, in the embodiment shown in FIG. 3, comprises adding a user to the collaboration. A user may be added to the collaboration in a number of ways, including, but not limited to, another user or administrator adding the user, the user adding himself to the collaboration, or the collaboration adding the user to the collaboration. In one embodiment, a user may be added by an administrator by modifying a characteristic or attribute of the collaboration to include the user. In one embodiment, an administrator may add a user to the collaboration by changing a user's access level to a system. In such an embodiment, all users of a system, such as a network, having a minimum access level may be automatically added to a collaboration. For example, all users having an access level of ‘administrator’ may be added to a collaboration by the system. In one embodiment, a collaboration may automatically add users belonging to a user group or team. For example, in such an embodiment, a collaboration may add all users who are members of a user group of a system, such as a corporate computer system, corresponding to sales.

In the embodiment shown in FIG. 3, step 304 comprises selecting a document in the collaboration. In one embodiment of the present invention, a user may select a document in an annotation by interacting with a user interface associated with the collaboration. For example, computer software may allow a user to interact with a collaboration, such as by selecting a document to work with. In another embodiment of the present invention, a user may select a document in the collaboration transparently by opening the document using a standard program for editing or viewing the document. In such an embodiment, a document in the collaboration may be automatically selected when a user opens the document using a standard word processing program, such as Microsoft Word™. Selecting in the context of this step may mean either directly interacting with the collaboration to select a document, or by indirectly interacting with the collaboration to select a document. Further, a user need not open, view, or otherwise interact with the document itself to select it. For example, in one embodiment, a user may view a listing of documents within the collaboration and select one. Using such an embodiment of the invention, the user may then associate an annotation with the document without opening or otherwise interacting with the document.

In the embodiment shown in FIG. 3, step 305 comprises creating an annotation. An annotation may be created in a wide variety of ways. For example, in one embodiment, an annotation may be recorded using a dictation machine, transferred to a computer system, and stored in the collaboration as an annotation. In one embodiment, an annotation may be created by interacting with the document with which the annotation may be associated. For example, a user may be able to select a document within the collaboration, interact with an interface associated with the collaboration, enter an annotation, such as a textual annotation, and store the annotation in the collaboration. In other embodiments, an annotation may be created using separate computer system or software. For example, a user may record a portion of a musical performance and store the recording as an annotation. In another embodiment, a user may draw a picture or diagram with an illustration program and store the picture or diagram as an annotation. In one embodiment, a user may open a document for editing or viewing. The user may then interact with the document to create an annotation. For example, a user may open a word processing document, select a portion of the document, create an annotation, and store the annotation in the collaboration. Such an embodiment may include a tool built into the word processing program to allow the creation of an annotation. Alternatively, or in addition, the embodiment may include a program for viewing word processing documents, different than the program used to create the document, that may allow a user to create an annotation, and store the annotation in the collaboration.

Step 306 comprises associating an annotation with the document, according to one embodiment of the present invention. An annotation may be associated with a document manually or automatically according to various embodiment of the present invention. For example, in one embodiment, a user may create an annotation and store the annotation in the collaboration. The user may then select the annotation and a document and associate the annotation with the document. In one embodiment, a user may open a document for viewing or editing, create an annotation, and store the annotation in the collaboration. In such an embodiment, the annotation may be automatically associated with the document. In a similar embodiment, a user may open a document for viewing or editing, select a coordinate, plurality of coordinates, a region, a selection of text, or other portion of the document, create an annotation, and store the annotation in the collaboration. The annotation may be automatically associated with the coordinate, plurality of coordinates, a region, a selection of text, or other portion of the document.

In one embodiment, an annotation may be associated with a coordinate within a document. In such an embodiment, a user may open a document for editing or viewing and select a point within the document. To select a point, the user may employ a program which may overlay a coordinate system over the document. For example, a program may overlay a coordinate system over a word processing document while the document is viewed or edited in Microsoft Word. In one embodiment, the user may use a program specifically created for annotating a document. In such an embodiment, the program may include functionality to determine a location of an annotation within a document, such as a coordinate system, or by determining a position relative to content within the document. For example, the program may determine a position of the annotation based upon its location relative to a word within the document, or a paragraph within the document.

In one embodiment, an annotation may be associated with one or more users. For example, an annotation may be associated with users for which the annotation may be intended. In such an embodiment, a user may create an annotation and select one or more users to be associated with the annotation. The selected users may then be able to access the annotation, while users not selected may not be able to access the annotation. Such an embodiment may be advantageous for specifically directing annotations to a particular user or group of users.

In one embodiment, an annotation may comprise a date and/or time associated with the annotation. In one embodiment, the date and/or time associated with the annotation may correspond to the creation of the annotation, the association of the annotation with the document, or the last change made to the annotation. In one embodiment, a plurality of dates and/or times may be associated with an annotation. For example, an annotation may comprise a date and time associated with one or more of the creation of the annotation, the association of the annotation with the document, and/or one or more changes made to the annotation. In such an embodiment, the annotation may also comprise a history of the changes made to the annotation such that the state of an annotation may be viewed at any point over the life of the annotation. For example, a user may be able to view the annotation as it existed after each revision to the annotation.

In one embodiment, a user may create a drawing annotation to be associated with a document. A user may associate the drawing annotation with the document by overlaying the drawing annotation over the document. For example, a layer may be created associated with the document, such that the document comprises a plurality of layers. A first layer of the document may comprise the content of the document, such as the text of a word processing document. A second layer may be added to the document for adding an annotation, such as a drawing. The second layer may be associated with a user or with an annotation. In such an embodiment of the present invention, a document and its associated layers may be viewed or edited individually or simultaneously. For example, a document having a three layers may comprise a first layer having the content of the document, a second layer having annotations added by a first user, and a third layer having annotations added by a second user. A viewer of the document may be able to view one or more of the layers simultaneously. For example, a view of the document may be able to view the first layer and third layer simultaneously. A viewer may advantageously be able to then view the second user's annotations in context with the content of the document, and without having to view the first user's annotations simultaneously. The viewer may also be able to view the second and third layers simultaneously to compare annotations made by the first and second users.

In one embodiment, each user within a collaboration may be assigned a layer associated with each document in the collaboration. In such an embodiment, a document may comprise a number of layers corresponding to the number of users within the collaboration. In on embodiment, a document may comprise a number of layers corresponding to the number of annotations associated with the document. In such an embodiment, each annotation may have its own layer within the document. In one embodiment, a document may comprise one layer per user in the collaboration. In such an embodiment, all of a user's annotations associated with a document may be stored in the same layer for that document.

In one embodiment the present invention, a document may a plurality of layers associated with it. For example, as described above, annotations associated with the document may be associated with a layer associated with the document. In one embodiment, the layers may be stored with the document. For example, a document may comprise a file format which may allow one or more layers to be stored as a part of the document. In such an embodiment, annotations may be stored as layers in the document file. In a related embodiment, annotations may be stored, unlayered, directly in the document file. Such an embodiment may be advantageous because a viewer of the document may be able to view the annotations without accessing the collaboration. In one embodiment, layers may be stored in the collaboration and associated with the document, but not stored directly in the document file.

In the embodiment shown in FIG. 3, step 307 comprises storing the annotation on a processor-based device. In one embodiment, the annotation is stored in a data storage system, such as data storage system 103 shown in FIG. 1. In one embodiment, the annotation is stored in a database, such as database 102 shown in FIG. 1. In one embodiment, a user may store the annotation and the document in the file system local to the device on which the document was created or edited. For example, a user may create a collaboration, and a document on a personal computer. The user may then create an annotation, associate the annotation with the document, and store the annotation on the personal computers hard drive. In such an embodiment, the user may be working alone on the document, and the personal computer may not be in communication with a server, database, or distributed storage system. In such an embodiment, the annotation may be stored as a file on the personal computer's hard drive separately from the document. Alternatively, or in addition, the annotation may be stored within the document file.

Steps 309 and 310, as shown in the embodiment shown in FIG. 3, comprise retrieving the document and the annotation associated with the document. In one embodiment of the present invention, a user within a collaboration may select a document in the collaboration and retrieve the document to view or edit. The user may select the document by selecting the document from an interface associated with the collaboration. In one embodiment, a user may select the document by opening the document in a program for editing or viewing the document, such as Microsoft Word.

After selecting the document 308, the document may be retrieved from a processor-based device. In one embodiment, the processor-based device may comprise a server running a database. In one embodiment, the processor-based device may comprise a distributed storage system. The document may be retrieved and transmitted to a device with which the user is interacting, such as, for example, a personal computer. Other suitable devices, such as PDAs or cell phones, may be advantageously employed as well.

The user may also select and retrieve an annotation associated with the document. In one embodiment, a user may select all of the annotations associated with the document. In such an embodiment, all of the annotations may be transmitted to the user's device. In one embodiment, a user may select one or more annotations, or one or more layers, to retrieve. In such an embodiment, a user may retrieve only those annotations selected. If the user selects one or more layers, the user may retrieve only the annotations associated with the document contained within the selected layers.

In one embodiment, annotations may be retrieved in portions or as a stream of data. For example, an audio or video annotation may comprise a large amount of data and may be stored in a distributed storage system. It may not be practical or cost-effective to transmit the entire audio or video annotation prior before outputting the annotation. In such an embodiment, an annotation may be streamed to a user requesting the annotation. For example, a user may select an audio annotation to be retrieved and output. According to one embodiment of the present invention, a portion of the audio file may be transmitted to the user. The portion of the audio annotation may be buffered by the user's processor-based device, such as a cell phone. Once the user's processor-based device has received a sufficient amount of annotation data, but less than all of the annotation data, the annotation may begin to be output to the user from the buffer. As the annotation is output from the buffer, additional annotation data may be transmitted from the data storage device. As annotation data is being output to the user, more annotation data may be loaded into the buffer. In such an embodiment, the user may only have to wait for a portion of the annotation data to be retrieved before the annotation is output to the user. Such a method of retrieval may be referred to as “streaming” as a stream of a data is sent from a data storage system and the stream is output to the user such that the entire annotation need not be retrieved prior to outputting the annotation to the user. Such an embodiment may be advantageous when a large annotation would take a significant amount of time to retrieve completely, but where data transfer rates between the user's processor-based device and a data storage system are fast enough to allow data to be buffered and output such that only a portion of the annotation needs to be retrieved prior to beginning output. The size of the buffer may be determined by the size of the annotation, the data rate, or bandwidth, between the user's processor-based device and the data storage system.

In one embodiment of the present invention, a user may retrieve an annotation and a document using different communication means. For example, in one embodiment, a user may retrieve a document with a PDA, where the PDA is configured to transmit and receive data from a cellular network. In such an embodiment, a user may retrieve the document using a packet switched transmission, such as GPRS, EDGE, WCDMA, or another packet-switched cellular transmission system. A user may then retrieve a voice annotation associated with the document using a circuit-switched connection, such as over a GSM, CDMA, or other circuit-switched cellular transmission system. Such an embodiment may be advantageous to minimize data transmission costs, or a circuit-switched cellular transmission may provide a more reliable means of transmitting audio data, with a reduced likelihood of latency or interruption during data transmission that may be present with packet-switched communications.

In one embodiment, a user may retrieve a document using a personal computer over a LAN or wide-area network (WAN). The user may then retrieve an audio annotation over a circuit-switched transmission means, such as a telephone connection. In such an embodiment, a user may receive an audio annotation over a telephone or modem connection. In one embodiment a user may receive an audio annotation over a streaming packet-switched transmission means, such as voice-over-IP.

After the annotations have been retrieved, one or more of the annotations may be output. In one embodiment, a user may retrieve all of the annotations associated with a document. In such an embodiment, all of the annotations may be output. In one embodiment, the user may select one or more annotations to enable or disable. For example, in one embodiment, a user may retrieve six annotations associated with a document. The user may enable a first annotation, a third annotation, and a sixth annotation. The first, third, and sixth annotations may then be output, while the second, fourth, and fifth annotations may not be output. In one embodiment, the user may retrieve all layers associated with a document. The user may then enable one or more layers. All annotations associated with each enabled layer may then be output, while the annotations associated with the un-enabled layers may not be output. In one embodiment, a user may select one or more layers to disable. In such an embodiment, all layers may be enabled by default. A user may then filter the desired layers by disabling one or more undesired layers. The disabled layers may then not be output. In one embodiment, all annotations may be output by default. A user may be able to disable on or more annotations, or one or more types of annotations, where the disabled annotations or types of annotations may not be output. In such an embodiment, a user may be able to disable all audio annotations, while leaving all text-based annotations enabled. All text-based annotations may then be output, while all audio annotations may not be output.

In one embodiment, one or more annotations may be filtered based on a date and/or time. For example, in such an embodiment, a user may be able to filter all annotations created after a specific date or time. Such an embodiment may be advantageous to show annotations made following a meeting at a specific time, or for annotations made on a specific date or at a specific time. In one embodiment, annotations may be filtered based on a range of dates and/or times.

In one embodiment, one or more annotations may be filtered based on a user or user group associated with the annotation. For example, in such an embodiment, all annotations created by members of a user group may be enabled, while all annotations created by any user not a member of the user group may be disabled. In one embodiment, annotations may be filtered based on one or more users or user groups. For example, two or more user groups may be associated with each other, such as a user group for Sales personnel and a user group for Marketing personnel. In such an embodiment, an annotation created by a member of the sales group may be enabled for members of both the Sales group and the Marketing group, but may be disabled for members of the Legal group. In one embodiment, a filter may be optionally applied by a user or user group. For example, a first user may optionally disable all annotations created by a second user. Alternatively, or in addition, a first user may be prevented from enabling annotations created by a second user. In such an embodiment, a user or an administrator may limit access to an annotation by specifying the user(s) or user group(s) having access to the annotation. In one embodiment, an access restriction to an annotation may be changed by a user. For example, a user may be able to enable a disabled annotation. In one embodiment, an access restrictions may not be changed by a user. For example, a user may not be able to enable a disabled annotation. Alternatively, or in addition, a user may not have the option of enabling a disabled annotation. For example, a user may not have any information indicating the existence of the annotation. In such an embodiment, an annotation may be designated as private, having a different access level, or intended for a specific user(s) or user group(s).

In one embodiment, an annotation may be automatically retrieved. For example, in one embodiment, a user's processor based device may automatically check for new annotations associated with a document. In such an embodiment, a user may be notified of the receipt of a new annotation. For example, in one embodiment, the processor-based device may notify the user by displaying a message on a screen, playing a sound, generating a vibration (such as with a haptic device built into a PDA or cell phone), flashing a light or LED, and/or sending the user an email. In one embodiment, the user may be notified that a new annotation is available, but the annotation is not retrieved. In such an embodiment, a user may be notified that a new audio annotation is available, but the annotation may not be retrieved until the user is able to listen to the annotation.

In the embodiment shown in FIG. 3, step 311 comprises outputting the annotation. In one embodiment, outputting the annotation may comprise outputting an audio annotation to one or more speaker in communication with the user's processor-based device. In one embodiment, outputting the annotation may comprise outputting a video annotation to a display, or to a display and one or more speakers in communication with the user's processor-based device. In one embodiment, outputting the annotation may comprise displaying text or a figure on a display device, such as a computer monitor or LCD screen incorporated into a PDA or cell phone.

While FIG. 3 shows one ordering of the steps of one embodiment of the present invention, the steps shown and described need not be performed in the order shown, nor must all of the steps shown or described be performed.

The foregoing description of the embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the this invention.

That which is claimed is:

1. A method for annotating a document, comprising:
creating a collaboration;
adding a document to the collaboration;
adding a user to the collaboration;
selecting the document;
creating an annotation;
associating the annotation with the document; and
storing the annotation on a processor-based device.

2. The method of claim 1, wherein associating the annotation with the document comprises:
selecting a coordinate within the document; and
associating the annotation with the coordinate.

3. The method of claim 1, wherein associating the annotation with the document comprises:
selecting a portion of the document; and
associating the annotation with the portion of the document.

4. The method of claim 1, wherein associating the annotation with the document comprises:
selecting the entire document; and
associating the annotation with the entire document.

5. The method of claim 1, wherein the annotation comprises at least one of an audio annotation, a video annotation, a textual annotation, a highlighter annotation, or a drawing annotation.

6. The method of claim 1, further comprising:
selecting the document;
creating a second annotation;
associating the second annotation with the document; and
storing the second annotation on the processor-based device.

7. The method of claim 1, further comprising:
selecting the document,
receiving the document,
receiving the annotation associated with the document, and
outputting the annotation associated with the document.

8. The method of claim 7, wherein receiving the annotation comprises receiving a data stream comprising the annotation.

9. The method of claim 8, wherein the data stream comprises one of a circuit-switched data stream or a packet-switched data stream.

10. The method of claim 9, wherein the packet-switched data stream comprises at least one of streaming audio, or streaming video.

11. The method of claim 1, wherein associating the annotation with the document comprises:
creating a first layer associated with the document, and
adding the annotation to the first layer.

12. The method of claim 11, wherein associating the annotation with the document further comprises:
creating a second annotation,
creating a second layer associated with the document, and
adding the second annotation to the second layer.

13. The method of claim 12, further comprising:
enabling the first layer;
disabling the second layer;
receiving the annotation and the second annotation; and
outputting the annotation, but not the second annotation.

14. The method of claim 1, wherein the document comprises one of a text document, a spreadsheet, a presentation, an audio file, or a video file.

15. The method of claim 1, further comprising storing the annotation in the document.

16. A system for annotating a document, comprising:
a device comprising a processor-and in communication with a data storage system, the device configured to:
select a document,
create an annotation,
associate the annotation with the document,
store the annotation on the data storage system,
receive the document from the data storage system,
receive the annotation, and
output the document and the annotation; and
wherein the data storage system comprises a processor, the data storage system configured to:
store the document,
store the annotation,
store an association between the document and the annotation,
transmit the document, and
transmit the annotation.

17. The system of claim 16, wherein the device is further configured to:
create a second annotation,
associate the second annotation with the document, and
store the annotation on the data storage system.

18. The system of claim 17, wherein the device is further configured to:
receive the document from the data storage system,
receive the second annotation, and
output the document and the second annotation.

19. The system of claim 16, wherein the device is further configured to:
create a first layer associated with the document, and
store the annotation in the first layer.

20. The system of claim 19, wherein the device is further configured to:
create a second layer associated with the document, and
store a second annotation in the second layer.

21. The system of claim 20, wherein the first device is configured to:
enable the first layer;
disable the second layer;
receive the annotation and the second annotation;
output the annotation, but not the second annotation.

22. The system of claim 16, wherein the first device is configured to receive a data stream comprising the annotation.

23. The system of claim 20, wherein the data stream comprises one of a circuit-switched data stream or a packet-switched data stream.

24. The system of claim 23, wherein the packet-switched data stream comprises at least one of streaming audio or streaming video.

25. The system of claim 16, wherein the device comprises a first device and further comprising a second device, the second device configured to:
select a document,
create an annotation,
associate the annotation with the document,
store the annotation on the data storage system,
receive the document from the data storage system,
receive the annotation, and
output the document and the annotation.

26. The system of claim 16, wherein the device comprises at least one of a computer, a cell phone, or a PDA.

27. A computer-readable medium comprising program code for annotating a document, the program code comprising:
program code for creating a collaboration;
program code for adding a document to the collaboration;
program code for adding a user to the collaboration;
program code for selecting the document;
program code for creating an annotation;
program code for associating the annotation with the document; and
program code for storing the annotation on a processor-based device.

28. The method of claim 27, wherein associating the annotation with the document comprises selecting a coordinate within the document and associating the annotation with the coordinate.

29. The method of claim 27, wherein associating the annotation with the document comprises selecting a portion of the document and associating the annotation with the portion of the document.

30. The method of claim 27, wherein the annotation comprises at least one of an audio annotation, a video annotation, a textual annotation, a highlighter annotation, or a drawing annotation.

31. The method of claim 27, further comprising:
selecting the document;
creating a second annotation;
associating the second annotation with the document; and
storing the second annotation on the processor-based device.

32. The method of claim 27, further comprising:
selecting the document,
receiving the document,
receiving the annotation associated with the document, and
outputting the annotation associated with the document.

33. The method of claim 32, wherein receiving the annotation comprises receiving a data stream comprising the annotation.

34. The method of claim 33, wherein the data stream comprises one of a circuit-switched data stream or a packet-switched data stream.

35. The method of claim 34, wherein the packet-switched data stream comprises at least one of streaming audio, or streaming video.

36. The method of claim 27, wherein the document comprises one of a text document, a spreadsheet, a presentation, an audio file, or a video file.

37. The method of claim 27, further comprising storing the annotation in the document.

38. A method for annotating a document, comprising:
creating a collaboration;
adding a user to the collaboration
adding a document to the collaboration;
creating an annotation;
associating the annotation with the document;
storing the annotation in the collaboration;
retrieving the annotation; and
outputting the annotation to first user.

39. The method of claim 38, wherein the user is the only member of the collaboration.

40. The method of claim 39, wherein the annotation comprises notes or revisions associated with the document.

41. The method of claim 40, wherein the annotation comprises an audio dictation of changes to be made to the document.
